(19) United States
(12) Patent Application Publication
(10) Pub. No.: US 2014/0266724 A1
(43) Pub. Date: Sep. 18, 2014

(54) AC CARRIER SENSING

(71) Applicant: InVue Security Products Inc., Charlotte, NC (US)

(72) Inventor: Gary A. Taylor, Fort Mill, SC (US)

(73) Assignee: InVue Security Products Inc., Charlotte, NC (US)

(21) Appl. No.: 14/206,043

(22) Filed: Mar. 12, 2014

Related U.S. Application Data
(60) Provisional application No. 61/787,543, filed on Mar. 15, 2013.

(51) Int. Cl. G08B 13/14

(52) U.S. Cl. CPC G08B 13/1445
USPC 340/568.3

(57) ABSTRACT

Embodiments of the present application are directed to merchandise display devices and methods for displaying an article of merchandise. In one example, a merchandise display device includes a mounting member configured to be secured to the article of merchandise and a tether operably engaged with the mounting member and comprising a pair of conductors. The pair of conductor are configured to provide power to the article of merchandise and to transmit a security signal to the mounting member.

### CROSS REFERENCE TO RELATED APPLICATIONS

This non-provisional utility patent application claims the benefit of priority of U.S. Provisional Application No. 61/787,543, filed on Mar. 15, 2013, entitled AC Carrier Sensing, the contents of which are hereby incorporated by reference in their entirety.

### FIELD OF THE INVENTION

Embodiments of the present invention relate generally to security devices for articles of merchandise in a retail environment.

### BACKGROUND OF THE INVENTION

Retailers routinely display articles of merchandise, such as portable computers (e.g. notebooks, laptops, tablets, etc.), e-readers, media players, and the like for customers to evaluate before making a purchase. These articles of merchandise are continually being made smaller and lighter in weight due to advances in technology and materials. As a result, such merchandise is increasingly vulnerable and susceptible to theft. At the same time, the retail price and profit margin for such merchandise continues to decline. Accordingly, these articles of merchandise need to be secured by a security device that effectively and cost efficiently protects the merchandise from theft.

It is common in the retail security industry to have electronic devices tethered to a store fixture to prevent theft yet allow a customer to interact with the device. The retailers and their customers want these tethers to be as unobtrusive as possible, making smaller diameter tethers desirable. One problem with keeping cable size small is the number of conductors needed to supply power and a sensing signal. Therefore, there exists a need for means to detect the merchandise without adding any extra conductors to the tether.

### BRIEF SUMMARY

Embodiments of the present application are directed to merchandise display devices and methods for displaying an article of merchandise. In one embodiment, a merchandise display device includes a mounting member configured to be secured to the article of merchandise and a tether operably engaged with the mounting member and comprising a pair of conductors. The pair of conductor are configured to provide power to the article of merchandise and to transmit a security signal to the mounting member. In some embodiments, the pair of conductors comprise a positive power line and a ground line. One of the pair of conductors may be a DC power line and may be configured to receive an AC signal for transmitting a security signal.

In one aspect, the merchandise security device may also include a capacitor in electrical communication with the pair of conductors for changing a pattern of the security signal. In other aspects, the mounting member may include a mechanical switch operably engaged with the capacitor, wherein opening of the mechanical switch is configured to change a pattern of the security signal. The merchandise display device may also include a plug and a cable operably engaged with the mounting member and the article of merchandise, wherein removal of the plug from the article of merchandise is configured to change a pattern of the security signal.

In another embodiment, a method for displaying and protecting an article of merchandise is provided. The method includes providing power through a tether having a pair of conductors to a mounting member with at least one of the pair of conductors. The mounting member is attached to the article of merchandise, and the tether is operably engaged with the mounting member. The method further includes providing a security signal through the tether and to the mounting member with at least one of the pair of conductors. According to one aspect of the method, the providing step includes injecting an AC signal onto one of the conductors, the conductor being a DC power line. The method may further include detecting a change in the AC signal indicative of an alarming condition. In other aspects, the method further includes analyzing the security signal for detecting an alarming condition. The method may also include changing a pattern of the security signal prior to analyzing the security signal.

According to another embodiment, a merchandise display device for displaying an article of merchandise is provided. The merchandise display device includes a mounting member configured to be secured to the article of merchandise and a tether operably engaged with the mounting member. The tether consists of a pair of conductors for transmitting both a DC and an AC signal onto the pair of conductors. The pair of conductors are configured to provide power to the article of merchandise with the DC and to transmit a security signal to the mounting member with the AC signal.

### BRIEF DESCRIPTION OF THE DRAWINGS

FIG. 1 is a schematic of a merchandise display device according to one embodiment of the present invention.

FIG. 2 is a schematic of a circuit for a merchandise display device according to one embodiment of the present invention.

### DETAILED DESCRIPTION OF EMBODIMENTS OF THE INVENTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

One or more embodiments of a merchandise display device 10 for securing an article of merchandise are described below and shown in FIG. 1. The article of merchandise M is typically a display model or an operational sample of electronic merchandise, such as portable computers (e.g. notebooks, laptops, tablets, etc.), e-readers, media players, and the like, for a customer to examine before making a decision to purchase the item. The article of merchandise M is typically displayed in a manner that permits a prospective purchaser to evaluate the operation and features of the merchandise, while protecting the merchandise from a potential thief. In one embodiment, a mounting member 12 with alarming circuitry may be attached to the article of merchandise M for detecting various alarming conditions, such as the article being removed from the mounting member. The mounting member 12 may be attached using any suitable technique, such as with an adhesive and/or mechanical means. A tether 14 may be operably engaged with the mounting member 12 at one end, while the opposite end may be secured to a base 16 or other display surface. The mounting member 12 may also be configured to detect an alarming condition of the tether, such as cutting or detaching the tether.

Embodiments of the present invention provide for the delivery of power to the article of merchandise M on display through a pair of conductors 18 in the tether 14, a positive power line and a ground line. An input power source 20 or controller may be in electrical communication with the conductors for transmitting power and other signals through the tether 14 and to the mounting member 12. Alternatively, the base may be configured to provide a security signal onto one of the conductors, or the input power source may be integrated with the base. In order to obtain a sense signal using only the power lines, one application is to simply detect when the power stops flowing. The problem with this method is that an article of merchandise typically stops pulling power when its battery is drained, which would cause a false alarm. Instead, one embodiment of the invention injects an alternating current (AC) signal or waveform onto the direct current (DC) power line. The article of merchandise M may ignore this signal and simply pass it on. This AC signal might be a sine wave or some other type of AC signal that is injected at a particular frequency or pattern. The AC signal may be injected while power is provided to the article of merchandise M such that power is uninterrupted to the article of merchandise. There are several embodiments of how to use this AC signal for sensing the presence of the article of merchandise M.

In one embodiment, a mechanical switch 22 on the mounting member 12 can be used for detecting a surface on the article of merchandise M such that when the article of merchandise M is removed, the switch opens. This switch 22 opening could cause a change in the AC signal, for example, by putting a resistor or a capacitor 28 or some other such circuit that changes the pattern of the injected signal. This change in pattern can then be detected on the return ground line.

In some embodiments, the mounting member 12 may be electrically connected to the article of merchandise M, such as with a micro-USB standard plug 24 or the like. A cable may be attached to the housing of the plug 24 and extend between the mounting member and the article of merchandise M such that the cable is shorted to ground when the plug is plugged into the article of merchandise. This shorting can also be used similarly to a switch in that an electronic component such as a resistor or a capacitor can change the AC signal depending on whether the plug housing is shorted to ground or not. In this implementation, it is irrelevant whether the article of merchandise M is pulling a current or not. However, as soon as the plug 24 is removed from the article of merchandise M, the shorted contact would open, changing the AC signal and causing an alarm.

In another embodiment, a micro or controller 26 in the mounting member 12 may be provided that takes the incoming power from the tether 14 and delivers it to the article of merchandise M. This micro 26 could monitor a number of things about the article of merchandise M including the above plug 24 housing being shorted or even something as complex as a software application running on the article of merchandise M that can communicate to the micro in the mounting member 12. This micro 26 could then use the AC carrier signal for any form of communication desired.

In some embodiments, the merchandise security device 10 is configured to filter out noise delivered to the article of merchandise M. In this regard, the merchandise security device may be configured to filter out security signals provided over the conductors 18. For example, the mounting member 12 and/or the base 16 may include a capacitor 28 for filtering out a security signal at a particular pattern or frequency. FIG. 2 shows one embodiment where both the mounting member 12 includes a capacitor 28 in electrical communication with the pair of conductors. The security signal may be injected on one of the pair of conductors 18, be filtered at the mounting member 12, and return to the base 16 via the other of the pair of conductors. The DC signal may continue on to the article of merchandise M, such as via plug 24 and associated cable. As such, only the DC signal is provided to the article of merchandise M, and the AC signal is able to be analyzed at the base. Alternatively, the AC signal may be filtered at the base.

The foregoing has described one or more embodiments of a merchandise security device for displaying and protecting an article of merchandise. Those of ordinary skill in the art will understand and appreciate that numerous variations and modifications of the invention may be made without departing from the spirit and scope of the invention. Accordingly, all such variations and modifications are intended to be encompassed by the appended claims.

That which is claimed is:

1. A merchandise display device for displaying an article of merchandise comprising:
a mounting member configured to be secured to the article of merchandise; and
a tether operably engaged with the mounting member and comprising a pair of conductors,
wherein the pair of conductor are configured to provide power to the article of merchandise and to transmit a security signal to the mounting member.

2. The merchandise display device of claim 1, wherein the pair of conductors comprise a positive power line and a ground line.

3. The merchandise display device of claim 1, wherein one of the pair of conductors is a DC power line and is configured to receive an AC signal for transmitting a security signal.

4. The merchandise display device of claim 1, further comprising a capacitor in electrical communication with the pair of conductors for changing a pattern of the security signal.

5. The merchandise display device of claim 4, wherein the mounting member comprises a mechanical switch operably engaged with the capacitor, and wherein opening of the mechanical switch is configured to change a pattern of the security signal.

6. The merchandise display device of claim 4, further comprising a plug and a cable operably engaged with the mounting member and the article of merchandise, wherein removal of the plug from the article of merchandise is configured to change a pattern of the security signal.

7. A method for displaying and protecting an article of merchandise comprising:
providing power through a tether having a pair of conductors to a mounting member with at least one of the pair of conductors, the mounting member attached to the article of merchandise and the tether operably engaged with the mounting member; and
providing a security signal through the tether and to the mounting member with at least one of the pair of conductors.

8. The method of claim 7, wherein providing the security signal comprises injecting an AC signal onto one of the conductors, the conductor being a DC power line.

9. The method of claim 8, further comprising detecting a change in the AC signal indicative of an alarming condition.

10. The method of claim 7, further comprising analyzing the security signal for detecting an alarming condition.

11. The method of claim 10, further comprising changing a pattern of the security signal prior to analyzing the security signal.

12. A merchandise display device for displaying an article of merchandise comprising:
a mounting member configured to be secured to the article of merchandise; and
a tether operably engaged with the mounting member and consisting of a pair of conductors for transmitting both a direct current and an alternating current onto the pair of conductors,
wherein the pair of conductor are configured to provide power to the article of merchandise with the direct current and to transmit a security signal to the mounting member with the alternating current.
